(19) United States
(12) Patent Application Publication
(10) Pub. No.: US 2019/0012663 A1
(43) Pub. Date: Jan. 10, 2019

(54) SYSTEMS AND METHODS FOR PROVIDING AN ARCHITECTURE FOR AN INTERNET-BASED MARKETPLACE

(71) Applicant: Robert Masters, Ashmore (AU)

(72) Inventor: Robert Masters, Ashmore (AU)

(21) Appl. No.: 15/643,331

(22) Filed: Jul. 6, 2017

(51) Int. Cl. G06Q 20/38; G06Q 20/10

(52) U.S. Cl. CPC G06Q 20/38215; G06Q 20/10

(57) ABSTRACT

Systems, methods, and computer-readable storage media providing a systems architecture for creating and distributing asset-backed tokens are disclosed. In embodiments, a server receives, a first entity, a request that identifies a value of assets of the first entity offered to back a value of tokens distributed via an Internet-based market platform. The server creates an offering of a first quantity of asset-backed tokens, and presents, via an Internet-based market platform, the offering to market participants who may purchase a portion of the asset-backed tokens to participate in the offering. The server processes payments from the market participants for purchases of the asset-backed tokens from the offering, and records information identifying quantities of asset-backed tokens purchased by each of the one or more market participants from the offering. The server provides funds received from the purchases to the first entity.

### TECHNICAL FIELD

The present application relates to system architectures and methods for providing an Internet-based marketplace.

### BACKGROUND

Having liquidity and liquid assets is often essential to growing a company. Liquidity is often required in order to manufacture new products, expand into new markets, and to undertake many efforts required to progress the company. For many companies liquid assets are obtained in multiple ways. For example, companies may use initial public stock offerings, obtain venture capital funds, or may take on loans to obtain cash. Often times these funds come with conditions and terms that are not preferred by the company. For example, a company may not desire to be publicly traded as that introduces various degrees of compliance issues. A venture capital fund provider or seed crowdfunding group may require an equity stake in the company which will forever benefit from company profits, but may introduce a cost of business that hinders the company's capability to compete in the market. Loans are generally governed in a manner in which terms and conditions are not properly tailored to the situation of the company and are therefore not ideal. An additional problem is that current systems utilized to accomplish these options are owned and controlled by a select few people. For example, a select few banks or a primary group of venture capital funders usually control these processes for their own benefit. This dynamic severely limits options for a company.

Some technological systems have been created that attempt to facilitate crowdfunding projects. These systems are able to directly bypass traditional liquidity sources and are able to reach individuals around the world. For example, on the website Kickstarter a person or company is able to post a project that any user of the Internet can view and donate funds to the poster of the project. A person donating funds is not allowed to receive a return on their investment, rather, they are allowed to receive specified rewards, such as a t-shirt, an early release of the product that is the subject of the posting, and the like. The majority of these posts, if successful, only generate between $1,000-$9,999. Because of this, a Kickstarter-like technology platform is not useful to a larger company that may have a larger funding need. It does not provide sufficient incentive to reliably obtain funds. It is not sophisticated enough to handle and enforce agreements between the poster and the donator. It also is not able to accept payments in various forms of digital or crypto currencies which can then be used in turn to send funds to the project poster. Accordingly, existing technological systems are not able to meet the needs of larger established companies that want to bypass the traditional structures for obtaining liquidity and the negative strings attached to those traditional structures (e.g., subjecting the company to burdensome regulatory and/or reporting requirements, granting an equity stake in the company, unfavorable loan terms, etc.), while also providing benefits to market participants.

### SUMMARY

The present application is directed to computational system architectures, methods, and devices which create and implement an Internet-based liquidity market. Such systems establish new lines of contact between, for example, a large corporation and an individual, where information and assets can be exchanged through a digital market platform. According to at least one embodiment, a market platform architecture may implement rules and functions for creating and managing a liquidity offering. The platform architecture may also implement rules and manage communications for accepting value from market participants using a plurality of digital and/or fiat currencies, for distributing and accounting for asset-backed tokens to market participants, for providing liquid assets to an entity, and for paying out proceeds between an entity and a market participant according to the established rules governed by the system.

According to one embodiment, an entity, such as a company, that sells goods or services may utilize the market platform architecture in order to request funds which are backed by specified assets/services of the entity. The entity may define various rules which govern how the funds will be used, when they will be paid back, when and how much additional value will be paid upon completion of a defined task, and any other terms that the entity will abide in order to incentivize funding. The market platform may utilize these rules to establish digital trusted relationships with one or more market participants in order to compile funds from one or more sources. The entity may then receive the funds from the market platform and act according to the established rules.

In yet another embodiment a market participant, such as an individual, may interact with an interface program hosted by the market platform architecture. This program may present a plurality of offerings from various entities which are requesting funds. The interface program may be configured to display one or more terms and conditions that govern an offering, and to allow the individual to participate in one or more offerings. The participant may participate in the offering by purchasing asset-backed tokens through the market platform architecture, and may manage its participation within the interface program. Such purchasing may be implemented using various payment forms which are offered by the market platform architecture. Upon the terms governing the offering being completed, the individual may receive funds via the interface program which are in excess of the funds used to purchase the asset backed tokens. Such funds may be distributed in the form of digital currency, tokens, or in any other manner provided by the market platform.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a block diagram illustrating a system architecture for creating and distributing asset-backed tokens in accordance with aspects of the present disclosure;

FIG. 2 is a block diagram illustrating an exemplary graphical user interface (GUI) for configuring an offering of a quantity of asset-backed tokens in accordance with aspects of the present disclosure;

FIG. 3 is a block diagram illustrating an exemplary GUI for viewing one or more offerings of asset-backed tokens in accordance with aspects of the present disclosure;

FIG. 4 is a block diagram illustrating an exemplary GUI for viewing details of an offering of asset-backed tokens in accordance with aspects of the present disclosure;

FIG. 5 is a block diagram illustrating an exemplary GUI for configuring a purchase of a quantity of asset-backed tokens corresponding to an offering in accordance with aspects of the present disclosure;

FIG. 6 is a block diagram illustrating an exemplary GUI for managing an account with a system configured to create and distribute asset-backed tokens in accordance with aspects of the present disclosure; and

FIG. 7 is a flow diagram of an exemplary method for creating and distributing asset-backed tokens in accordance with aspects of the present disclosure.

### DETAILED DESCRIPTION

Various features and advantageous details are explained more fully with reference to various aspects of the non-limiting embodiments that are illustrated in the accompanying drawings and detailed in the following description. Descriptions of well-known processing techniques, components, and equipment are omitted so as not to unnecessarily obscure the invention in detail. It should be understood, however, that the detailed description and the specific examples, while indicating aspects of the invention, are given by way of illustration only, and not by way of limitation. Various substitutions, modifications, additions, and/or rearrangements within the spirit and/or scope of the underlying inventive concept will become apparent to those skilled in the art from this disclosure.

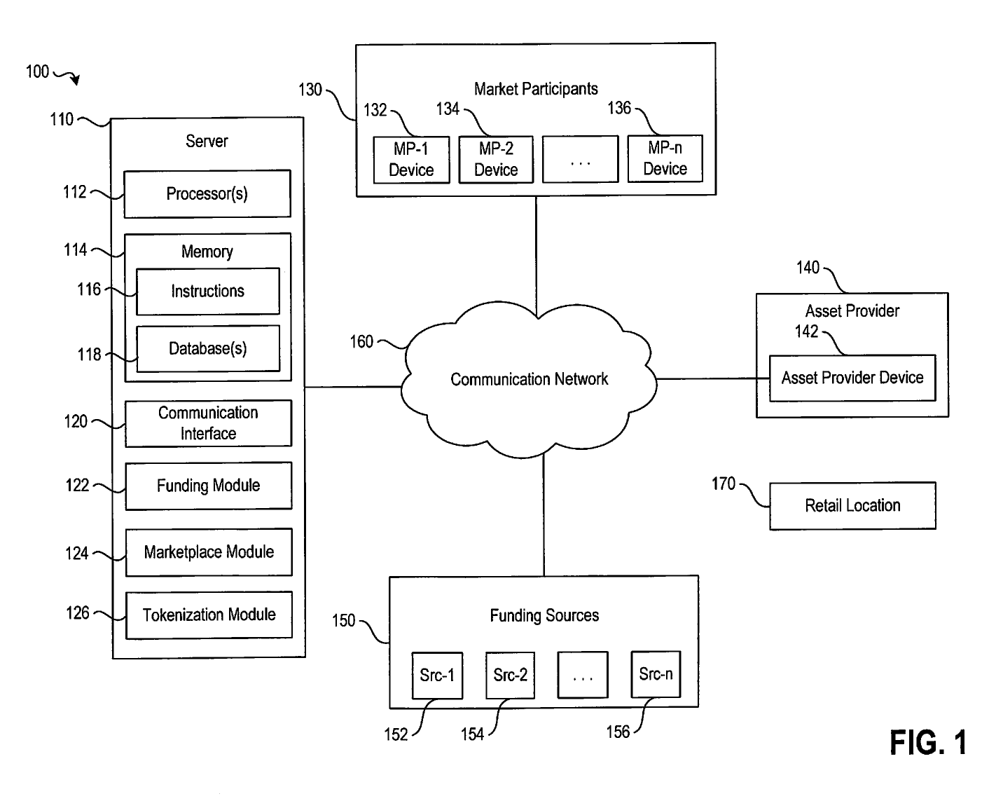

Referring to FIG. 1, a block diagram illustrating a system architecture for creating and distributing asset-backed tokens in accordance with aspects of the present disclosure is shown as a system 100. As shown in FIG. 1, the system 100 includes a server 110, a plurality of market participants 130, an asset provider 140, one or more funding sources 150, and a communication network 160. As described in more detail below, the server 110 may be configured to provide an Internet-based market platform configured to create tokens having a value that is backed by assets of the asset provider 140, and to provide a marketplace where the asset-backed tokens may be purchased by the plurality of market participants. It is noted that although FIG. 1 illustrates only one asset provider, in aspects, the system 100 may include a plurality of different asset providers, and each of the tokens created by the Internet-based market platform may have a value that is backed by assets of at least one of the plurality of different asset providers.

The communication network 160 may communicatively couple the server 110 to devices associated with the plurality of market participants 130, the asset provider 140, and the plurality of funding sources 150. For example, the communication network 160 may communicatively couple the server 110 to the plurality of market participants 130 via a plurality of market participant devices 132, 134, other market participant devices (not shown), 136. In aspects, the plurality of market participant devices 132-136 may include smartphones, tablet computing devices, smartwatches, personal computing devices, laptop computing devices, and other types of network-enabled personal electronic devices. Additionally, the communication network 160 may communicatively couple the server 110 to the asset provider 140 via an asset provider device 142, and may communicatively couple the server 110 to the plurality of funding sources 150 via funding source devices 152, 154, other funding source devices, 156, such as nodes/servers configured to facilitate transactions with respect to one or more types of currency.

Although not shown in FIG. 1, it should be understood that each of the plurality of market participant devices 132-136, the asset provider device 142, and each of the plurality of funding source devices 152-156 may include one or more processors, memory devices, communication interfaces, input/output (I/O) devices, display devices, and the like. In aspects, the memory devices may store instructions that, when executed by the one or more processors, cause the one or more processors to perform the operations described in connection with each of these devices, respectively, in accordance with aspects of the present disclosure. For example, a market participant device (e.g., one of the market participant devices 132-136) may include an application configured to present information associated with offerings of asset-backed tokens to a user of the market participant device, receive inputs from the user, and facilitate an exchange of information between the server 110 and the market participant device, such as to facilitate a purchase of a quantity of asset-backed tokens by the user/market participant) in accordance with aspects of the present disclosure.

In aspects, the application may be a web browser configured to access and present information associated with one or more web pages, and the Internet-based market platform provided by the server 110 may include one or more web pages served to the market participant device via the communication network 160. In additional aspects, the application may be a standalone application developed by an operator of the server 110 that may be downloaded to the market participant device. For example, the operator of the server 110 may create an application configured provide at least a portion of the functionality of the Internet-based market platform, and the market participant may download the application from a web page (e.g., a web page associated with the operator of the server 110) and install the application on the market participant's device, such as a personal computing device or laptop computing device. As another example, the application created by the operator of the server 110 may be downloaded to, and installed on the market participant's mobile device (e.g., a smartphone, a tablet computing device, and the like). Similarly, the Internet-based market platform provided by the server 110 may be accessed by the asset provider 140 via a web browser executing on the asset provider device 142 or via an application installed on the asset provider device 142. Additional aspects of functionality that may be provided to the plurality of market participants 130 and the asset provider 140 (and other asset providers not shown in FIG. 1) are described in more detail below.

The communication network 160 may be a wired network, a wireless network, or may include a combination of wired and wireless networks. For example, the communication network 160 may be a local area network (LAN), a wide area network (WAN), a wireless WAN, a wireless LAN (WLAN), a metropolitan area network (MAN), a wireless MAN network, a cellular data network, a cellular voice network, the Internet, etc. In aspects, the communication network 160 may communicatively couple various devices of system 100 using communication links established according to one or more communication protocols or standards (e.g., an Ethernet protocol, a transmission control protocol/internet protocol (TCP/IP), an institute of electrical and electronics engineers (IEEE) 802.11 protocol, and an IEEE 802.16 protocol, a 3rd generation (3G) protocol, a 4th generation (4G)/long term evolution (LTE) protocol, a next generation (NR) network protocol, a peer-to-peer communication protocol, etc.).

As shown in FIG. 1, the server 110 includes one or more processors 112, a memory 114, a communication interface 120, a funding module 122, a marketplace module 124, and a tokenization module 126. The memory 114 may include read only memory (ROM) devices, random access memory (RAM) devices, one or more hard disk drives (HDDs), flash memory devices, solid state drives (SSDs), other devices configured to store data in a persistent or non-persistent state, or a combination of different memory devices. In aspects, the memory 114 may store instructions 116 that, when executed by the one or more processors 112, cause the one or more processors 112 to perform the operations described in connection with the server 110 with reference to FIGS. 1-7. In aspects, the instructions 116, when executed by the one or more processors 112, may cause the one or more processors 112 to perform aspects of the operations described herein with reference to the funding module 122, the marketplace module 124, and/or the tokenization module 126. In aspects, the memory 114 may also store information associated with a database 118. As described in more detail below, the information stored at the database 118 may include information for tracking, managing, and controlling ownership of asset-backed tokens offered via the Internet-based market platform. In aspects, the database 118 may be external to the server 110. For example, the database 118 may be stored at memory devices accessible to the server 110 via the communication network 160. Additionally, it is noted that the database 118 may be deployed in a centralized manner, or may be deployed in a distributed or decentralized manner, which may provide improved fault tolerance. It is noted that although FIG. 1 illustrates the server 110 as a single block, the system 100 is not limited to a single server. Instead, it should be understood that the server 110 may be implemented in, or provided by a standalone server, or may be implemented in, or provided by multiple servers and/or computing resources (e.g., processors, memory devices, and the like) distributed across one or more networks. When implemented in a distributed configuration, the multiple servers and/or computing resources may be distributed across networks spanning a plurality of geographic locations.

In aspects, the communication interface 120 may be configured to communicatively couple the server 110 to one or more networks, such as the communication network 160. The communication interface 120 may be configured to communicatively couple the server 110 to the communication network 160 via one or more wired or wireless connections established according to one or more communication protocols or standards (e.g., an Ethernet protocol, a transmission control protocol/internet protocol (TCP/IP), an institute of electrical and electronics engineers (IEEE) 802.11 protocol, and an IEEE 802.16 protocol, a 3rd generation (3G) protocol, a 4th generation (4G) protocol/long term evolution (LIE) protocol, a next generation (NR) network protocol, etc.).

In aspects, the functionality provided by one or more of the funding module 122, the marketplace module 124, and/or the tokenization module 126 may be implemented or performed with a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions of one or more of the modules 122-126 described herein. As described in various places below, each of the funding module 122, the marketplace module 124, and the tokenization module 126 may be configured to facilitate various aspects of the operations provided by the server 110 in accordance with aspects of the present disclosure.

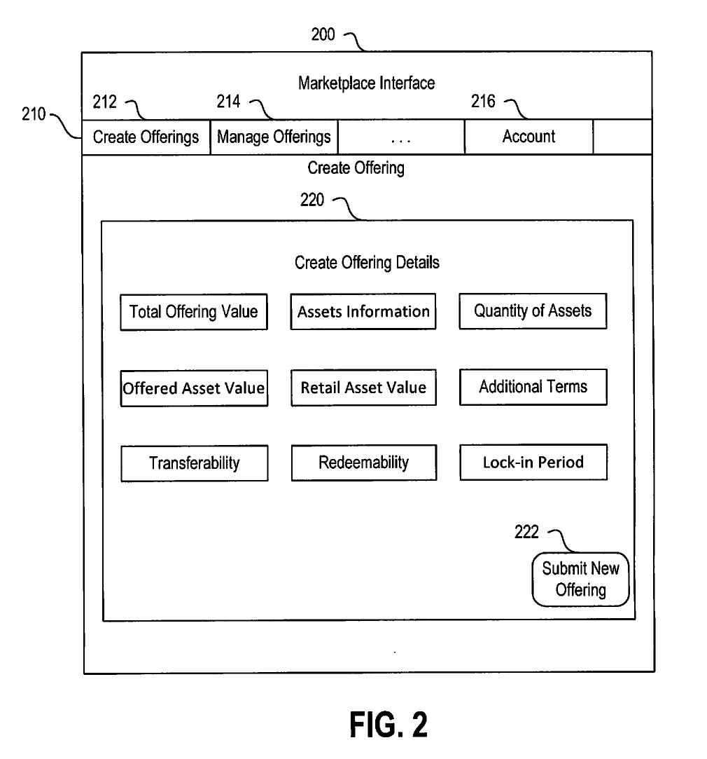

In aspects, the marketplace module 124 may be configured to provide and/or support one or more graphical user interfaces (GUIs) of an Internet-based market platform configured to provide offerings that enable the plurality of market participants to purchase tokens having a value that is backed by assets of the asset service provider 140 (or another asset provider not shown in FIG. 1), where the funding module 122 provides a first amount of funds received from the purchase of the asset-backed tokens to the asset provider (e.g., the offering enables the asset provider to raise capital), and where the asset provider returns a second amount of funds (that is greater than the first amount of funds) to the owners of the asset-backed tokens. In aspects, the Internet-based market platform may include one or more GUIs configured to exchange information between the server 110 and the asset provider device 140. For example, the one or more of the GUIs may be configured to compile information from the asset provider 140 (e.g., information associated with assets that may be used to back the value of a quantity of tokens generated by the server 110, parameters for returning the funds to market participants, etc.) that may be utilized to create an offering that is presented to the plurality of market participants, as described in more detail below with reference to FIG. 2. In aspects, the Internet-based market platform may include one or more GUIs configured to exchange information between the server 110 and the plurality of market participant devices 132-136, such as to facilitate the purchase of asset-backed tokens by one or more of the plurality of market participants 130. As described in more detail below, the one or more GUIs supported and/or provided by the marketplace module 124 may be provided via one or more web pages and/or via applications executing on various ones of the plurality of market participants 130 and the asset provider 140. Additional aspects of the various graphical user interfaces provided by and/or supported by the marketplace module 124 are described in more detail below.

In aspects, the funding module 122 may be configured to compile and distribute funds to various entities operating within the system 100. For example, as described briefly above, the plurality of market participants 130 may be presented with one or more offerings of asset-backed tokens via the Internet-based market platform. When a market participant desires to purchase a quantity of asset-backed tokens corresponding to an offering, the market participant may interact with a GUI of the Internet-based market platform to provide payment information that identifies a source of funds to be used to purchase the desired quantity of asset-backed tokens.

As shown in FIG. 1, the funding module 122 may be configured to utilize a plurality of funding sources 150. In aspects, the plurality of funding sources 150 may include a first funding source 152, a second funding source 154, other funding sources, and an n^{th} funding source 156. In aspects, the plurality of funding sources 150 may include funding sources associated with different types of funds. For example, the plurality of funding sources 150 may include: one or more sources of cryptocurrency, such as Bitcoin, Ethereum, Litecoin, and the like; one or more sources of fiat currency, such as bank accounts established at one or more banks; credit accounts, such as a credit card accounts associated with one or more credit card providers; one or more digital wallet accounts, such as a PayPal account; and a market participant account maintained by the server 110 and configured to hold fiat currency, asset-backed tokens purchased from offerings by the market participant and which may be used by the market participant to purchase additional asset-backed tokens in connection with other offerings.

In an aspect, one or more sources of cryptocurrency may further include a cryptocurrency offered by the operator of the server 110. In this aspect, units (also referred to as “coins”) of the cryptocurrency may be purchased by the market participants irrespective of the various offerings available via the Internet-based market platform, and then used to purchase asset-backed tokens from one or more of the offerings. In aspects, market participants that hold units of the cryptocurrency offered by the operator of the server 110 may receive a portion of the transaction fees deducted by the funding module 122 (described in more detail below), which may be deposited into the market participant's account maintained by the server 110. In some aspects, the cryptocurrency offered by the operator of the server 110 may be a native currency for the system 100, which may require that asset-backed tokens be purchased using the native currency. In such aspects, the funding module 122 may be configured to convert various types of other currencies to the native currency of the system 100 to effectuate the purchase of the asset-backed tokens. However, in other aspects, the cryptocurrency offered by the operator of the server 110 may be one of a plurality of types of currencies that may be used to purchase quantities of asset-backed tokens.

In aspects, purchases made using cryptocurrency may be restricted to particular cryptocurrencies. For example, there are presently hundreds of cryptocurrencies currently available and new cryptocurrencies are frequently being introduced to the market. Maintaining/updating the funding module 122 to support purchases across such a large number of different cryptocurrencies would impose a large administrative burden on the operator of the server 110, who would need to update the funding module 122 every time a new cryptocurrency was introduced, etc. To reduce or eliminate this burden, the funding module 122 may be configured to support purchase using a subset of the available cryptocurrencies. In aspects, the subset of cryptocurrencies may be limited to a particular number cryptocurrencies designated by an operator of the server 110. In aspects, the particular number of cryptocurrencies supported by the funding module 122 may vary depending the current state of the cryptocurrency market and the available cryptocurrencies. For example, a newly created cryptocurrency may not be selected for inclusion of the subset of cryptocurrencies supported by the funding module 122, but as time passes and that cryptocurrency matures, the operator of the server 110 may update the funding module 122 to support that cryptocurrency. As another example, if the operator determines that a particular cryptocurrency included in the supported subset of cryptocurrencies is underperforming or is otherwise undesirable (e.g., long delays associated with processing transactions involving the particular cryptocurrency, declining value, high fees, etc.), it may be removed from the subset of cryptocurrencies. In aspects, a cryptocurrency may be removed from the subset by disabling the functionality of the funding module 122 that supports the removed crypto currency. In this manner, should the operator subsequently decide add the cryptocurrency back into the subset, the operator can merely reactivate the functionality of the funding module 122.

In aspects, the funding module 122 may be configured to convert funds of a first type to funds of a second type. For example, when the market participant purchases a quantity of asset-backed tokens having a value of $500 using a cryptocurrency, the funding module 122 may be configured to determine a number of units of the cryptocurrency representative of $500, and may initiate a transfer of the determined number of units of the cryptocurrency to operator of the server 110. In aspects, the transfer may be recorded onto a blockchain associated with the cryptocurrency. Upon completing the transfer, the funding module 122 may be configured to convert the transferred units of the cryptocurrency to a second currency type, such as fiat currency, which may then be provided to the asset provider 140. In aspects, the funding module 122 may be configured to facilitate other types of funds conversions, such as converting fiat currency to one or more types of cryptocurrency, converting a first type of cryptocurrency into a second type of cryptocurrency, and the like. It is appreciated that funding module may be configured to access one or more currency exchanges (both fiat and digital cryptocurrency exchanges) in order to determine conversion rates for fund conversions.

In aspects, the funding module 122 may be configured to pay/distribute funds to market participants upon the conclusion of an offering. For example, as briefly explained above, publication of an offering via the Internet-based market platform may result in distribution of a first amount of funds (e.g., an amount of funds corresponding to the value of asset-backed tokens purchased by market participants) to an asset provider, and the asset provider may subsequently provide a second amount of funds (e.g., an amount that is higher than the first amount of funds) to the system 100. It is noted that in aspects, the funding module 122 may deduct/charge a transaction fee from one or more types of transactions executed by the various parties interacting with the system 100. For example, a transaction fee may be deducted during purchases of asset-backed tokens by the market participants, distributing the first amount of funds to the asset provider, receiving the second amount of funds from the asset provider, and distributing the second amount of funds to the market participants. In aspects, a size of the transaction fee may vary depending on the particular transaction being executed (e.g., if the transaction requires conversion of cryptocurrency, etc.).

In aspects, the second amount of funds may be proportionately distributed among the market participants such that each market participant receives an amount of funds equal to the value of their initial purchase plus an additional amount. For example, assume that two market participants purchased 100% of the asset-backed tokens associated with an offering having a total offered value of $10,000. If the two market participants each purchase half of the asset-backed tokens, the funding module 122 may initiate operations to compile a first amount of funds totaling $10,000, with each of the each market participants making purchases of $5,000. In exchange for their purchases, each of the market participants would own half of the asset-backed tokens associated with the offering. Subsequently, the asset provider 140 may return a second amount of funds (e.g., $12,000) to the market participants, where the second amount of funds is greater than the first amount of funds (e.g., $10,000). The funding module 122 may be configured to distribute the second amount of funds to the market participants in proportion to their respective ownership of the asset-backed tokens. For example, in the scenario described above, each of the two market participants owns half of the asset-backed tokens, and would each receive half, or $6,000, from the distribution of the second amount of funds. Thus, market participants that participate in an offering may collectively contribute a first amount of funds through the purchase of the asset-backed tokens, and receive, at a later time, a second, higher, amount of funds (e.g., the second amount of funds includes the first amount of funds plus an additional amount of funds).

As another example, suppose that the total the offered value (e.g., a value representing a valuation of the assets offered by the asset provider to back an amount of funds that the asset provider desires to raise) for an offering is $10,000, and the two market participants purchase all of the asset-backed tokens associated with the offering, where a first market participant purchases 75% of the asset-backed tokens (e.g., $7,500) and a second market participant purchase the remaining 25% of the asset-backed tokens (e.g., $2,500). If the asset provider returns $12,000 in accordance with the terms of the offering, the first market participant may receive $9,000 (e.g., a 20% gain in value) from the distribution of the second amount of funds, and the second market participant may receive $3,000 (e.g., a 20% gain in value) from the distribution of the second amount of funds.

In aspects, the server 110 may be configured to generate documentation that may be recorded to evidence a security interest in the assets offered to back the value of the asset-backed tokens purchased from the offering by the market participants. In aspects, the documentation may be automatically recorded with appropriate entities to perfect the security interests of the market participants. Additionally, upon receiving the second amount of funds from the asset provider, the server 110 may be configured to generate documentation to release the claimed security interests in the assets, and may automatically record that documentation with the appropriate entities.

In aspects, the tokenization module 126 may be configured to issue the asset-backed tokens that are purchased by the plurality of market participants in connection with offerings made available via the Internet-based market platform. In aspects, the tokenization module 126 may be configured to determine the number of tokens generated for each offering based on a base unit of measurement. For example, if an offering had a valuation of $1,000,000 USD, and the base unit of measurement was $1 USD, the tokenization module 126 may generate 1,000,000 tokens for the offering. In aspects, the number or quantity of tokens generated may be such that each token has a one-to-one correspondence to the base unit of measurement. In aspects, utilizing a base unit of measurement to determine the number of tokens needed ensures that each token purchased represents the same value. For example, assume that a first market participant is using a first currency (e.g., Bitcoin) and a single unit of the first currency (e.g., 1 Bitcoin) has a value of $2,610.77 USD, while a second market participant is using second currency (e.g., pesos) and a single unit of second currency (e.g., a single peso) has a value of $0.055 USD. To purchase a quantity of 100 asset-backed tokens having a benchmarked value of $100 USD (e.g., each token represents $1 USD), the first market participant may purchase the quantity of asset-backed tokens using approximately 0.04 Bitcoin, while the second market participant may purchase the quantity of asset-backed tokens using 1,822.22 pesos. As shown in this example, the first market participant and the second market participant contributed a different number of currency units to make their respective purchase of 100 asset-backed tokens, but the value represented by their purchases is equivalent (e.g., $100 USD).

Using a base unit of measurement to benchmark the value associated with asset-backed tokens generated in connection with an offering, and then generating the quantity of asset-backed tokens such that there is a one-to-one correspondence between the number of asset-backed tokens generated and the offering value may improve the performance of the server 110 and reduce the computational complexity required to administer one or more aspects of the present disclosure. For example, assume that an offering has a value of $500,000,000 USD, and that there are 20,000 market participants participating in the offer. In a scenario where each market participant making a purchase in an offering receives 1 token (e.g., the token signifies the market participant's purchase), 20,000 tokens would be issued. However, the value of the purchases across all 20,000 market participants may vary greatly, with some market participants contributing $1,000,000 or more while other market participants contributed less than $5,000. If the tokenization module 126 were to generate tokens in this manner, rather than using the benchmarking technique described above, returning funds to the market participants in response to receiving the second amount of funds from the asset provider 140 may be burdensome and expensive in terms computational resources used and time consumed by the funding module 122.

For example, as explained above, the value of the funds returned to each of the market participants should be proportional to the value of the purchases made by each market participant. However, in the previously described scenario where tokens were issued to signify that a market participant merely made a purchase in the offering, the funding module 122 would need to compile information that indicates the purchase amounts for all 20,000 market participants, and then calculate the relative percentage of the offering value purchased by each of the 20,000 market participants. Additionally, utilization of many different types of funds (currencies) and funding sources by the market participants may further complicate this process, as differences in value between all of the different types of funds would also need to be accounted for. Once this information is determined, the funding module 122 would then be able to distribute the second amount of funds to the 20,000 market participants such that each market participant received a portion of the second amount of funds that is proportional to the relative percentage of the offering value they purchased. This would require a large amount of computing resources and time to compile this information and would be inefficient.

By contrast, assume that, in the scenario described above where the offering value was $500,000,000 USD and that there were 20,000 market participants, each asset-backed token was benchmarked to $1 USD (e.g., 500,000,000 asset-backed tokens are issued to/purchased by the market participants). As the 20,000 market participants purchase different quantities of asset-backed tokens using various types of funds and funding sources, the number of asset-backed tokens purchased by each market participant may be recorded (e.g., in the database 118). Now, assume that the second amount of funds is $600,000,000, which is 1.2 times the value of the offering purchased by the market participants. By benchmarking the value of the asset-backed tokens, the second amount of funds may be allocated proportionately to each of the 20,000 market participants by multiplying the number of asset-backed tokens purchased for each market participant by 1.2. For example, the allocation of the second amount of funds to a market participant that purchased 125,000,000 asset-backed tokens (representing a benchmarked value of $125,000,000 USD) may be calculated as 125,000,000*1.2=150,000,000, which represents a benchmarked value of $150,000,000 USD. Thus, the market participant would receive a distribution of $150,000,000 from the second amount of funds. As shown above, benchmarking the asset-backed tokens improves the operations of the server 110 by increasing the speed at which the allocation of the second amount of funds can be determined, and by reducing the computational resources required to perform the allocation calculations.

In aspects, the tokenization module 126 may be configured to record information that identifies each market participant's ownership of asset-backed tokens on an offering by offering basis in the database 118. For example, the tokenization module 126 may generate a first set of records at the database 118 in connection with a first offering, and may generate a second set of records at the database 118 in connection with a second offering. The first set of records may include information that identifies details of the first offering, as well as information identifying the quantity of asset-backed tokens of the first offering purchased by each market participant, and the second set of records may include information that identifies details of the second offering, as well as information identifying the quantity of asset-backed tokens of the second offering purchased by each market participant.

In aspects, the tokenization module 126 may also be configured to record information evidencing each market participant's ownership of asset-backed tokens on a blockchain. It is noted that recording the ownership information may not result in, or involve a transaction using a cryptocurrency. Instead, recording data, such as information that identifies ownership of asset-backed tokens, to a blockchain may provide a level of trust between the plurality of market participants 130, the asset provider 140 (and other asset providers not shown in FIG. 1), and the operator of the server 110. For example, due to the static nature of information written to a blockchain (e.g., the information is not modified or removed) the ownership information recorded on the blockchain provides an immutable record that may be utilized to verify the accuracy of the database 118. This may increase trustworthiness of the system 100 (e.g., because the database 118 can be audited and proved up against the corresponding records written on the blockchain) in accordance with aspects of the present disclosure.

As explained above, the tokenization module 126 may be configured to generate a quantity of tokens that is equal to the benchmarked offered value of an offering. For example, assume that the asset provider 140 has assets that have an actual value of $35,000,000 USD, and that the asset provider desires to raise $25,000,000 in capital. In accordance with aspects of the present disclosure, the asset provider 140 may create an offering having an offered value of $25,000,000 USD, where the offered value is based on assets of the asset provider 140, and the terms of the offering may specify that the market participants purchasing asset-backed tokens of this offer will receive a 20% return on the value of each purchased token. In this aspect, the tokenization module 126 may generate 25,000,000 asset-backed tokens that may be purchased by market participants interested in this offering.

When the second amount of funds is received from the asset provider in connection with the terms of this offering, the value of the second amount of funds may be $30,000,000 USD (e.g., $25,000,000*1.2=$30,000,000). Thus, the offering has resulted in each market participant receiving the benchmarked value for each asset-backed token that they purchased, plus an additional amount or return. In aspects, the additional amount may be deposited to an account of each market participant with the server 110. The market participants may then use the asset-backed tokens purchased in this now completed offering, which retain their benchmarked value, to purchase asset-backed tokens associated with one or more additional offerings available through the Internet-based market platform, or may “cash out” their asset backed tokens (e.g., convert the asset-backed tokens to fiat currency, cryptocurrency, etc.).

In additional aspects, the tokenization module 126 may be configured to generate an amount of tokens that is greater than the offered value of an offering. For example, assume that in the scenario above, where offering had an offered value of $25,000,000 USD, and that the terms of the offering specify that market participants purchasing asset-backed tokens of this offer will receive a 20% return on the value of each purchased token. In this aspect, the tokenization module 126 may determine that the total number of asset-backed tokens to be generated is 30,000,000. Of these 30,000,000 asset-backed tokens, the tokenization module 126 may make 25,000,000 asset-backed tokens available for purchase by the market participants and may withhold the remaining 5,000,000 asset-backed tokens. When the second amount of funds (e.g., the $30,000,000 USD) is received from the asset provider 140, the tokenization module 126 may issue the 5,000,000 reserved asset-backed tokens, which represent the 20% return, to the market participants. In this manner, the second amount of funds may be represented in the system 100 as asset-backed tokens, which may be used to purchase additional asset-backed tokens in other offerings available via the Internet-based market platform. It is noted that when a market participant uses asset-backed tokens from a first offering (e.g., a completed offering) to purchase asset-backed tokens of a second offering, ownership of the asset-backed tokens of the first offering may be transferred from the market participant to the operator of the system 100, which may be recorded in the database 118 and/or the blockchain (e.g., for trust/validation purposes). Additionally, information indicating the market participant's ownership of the quantity of asset-backed tokens purchased form the second offering may be recorded in the database 118 and/or the blockchain (e.g., for trust/validation purposes).

As described briefly above, during operation, the asset provider 140 may access the Internet-based market platform and create an offering configured to provide liquid assets/capital to the asset provider 140 and to provide a return to market participants. In aspects, operations to create an offering may be initiated in response to receiving, by the server 110 from an asset provider, such as the asset provider 140, a request that identifies a value of assets of the asset provider offered to back a value of tokens distributed via an Internet-based market platform. For example, and referring to FIG. 2, a block diagram illustrating an exemplary GUI for configuring an offering of a quantity of asset-backed tokens in accordance with aspects of the present disclosure is shown as a GUI 200. As shown in FIG. 2, GUI 200 includes one or more tabs 210 which facilitate navigation by the user/market participant to one or more screen views providing information corresponding to the respective tabs. For example, in FIG. 2, GUI 200 includes a Create Offerings tab 212, a Manage Offerings tab 214, other tabs, and an Account tab 216.

In the specific example illustrated in FIG. 2, Create Offerings tab 212 is selected, and a Create Offering interface 220 is presented within the GUI 200. The Create Offering interface 220 may enable an asset provider, such as the asset provider 140, to configure a new offering that is to be presented to the plurality of market participants via the Internet-based market platform. In aspects, the Create Offering interface 220 may provide a plurality of data fields configured to capture information descriptive of various aspects of the offering. In aspects, at least a portion of the information captured via the Create Offering interface 220 may form a control policy configured to trigger one or more operations with respect to a quantity of the asset-backed tokens purchased from the offering. It is noted that the exemplary data fields illustrated in FIG. 2 and described below with respect to the Create Offering interface 220 have been provided for purposes of illustration, rather than by way of limitation, and the present disclosure is not to be limited to the specific examples disclosed herein.

For example, a “Total Offering Value” data field may be configured to capture information associated with the amount of capital that the asset provider 140 desired to raise (e.g., the first amount of funds in many of the examples above). An “Assets Information” data field may be configured to capture information associated with the assets of the asset provider 140 offered to back a value of tokens distributed via an Internet-based market platform in connection with the offering being created. In aspects, the asset information may include information that describes the assets, such as whether the assets are associated with physical goods or services. In aspects, a “Quantity of Assets” data field may identify a number of units of the asset that the asset provider is associating with the offer. An “Offered Asset Value” data field may be configured to capture information regarding what portion of the value of the offered assets is attributable to the offer, and a “Retail Asset Value” may be configured to capture information regarding a “market” value of the assets, which may be different from the offered asset value. For example, as explained above, the asset provider 140 may create an offering having total offering value of $500,000, indicate that the asset provider 140 has a quantity of assets (e.g., 100 motorcycles) having an offered asset value of $5,000 per unit of the assets (e.g., per motorcycle) and a retail asset value of $7,000.

In aspects, the data fields of the Create Offering interface 220 may also include an “Additional Terms” data field, a “Transferability” data field, a “Redeemability” data field, a “Lock-in Period” data field, and a data field for providing “Additional Asset Data.” The “Lock-in Period” data field may be configured to capture information associated with a time criterion. In aspects, the time criterion may specify a minimum amount of time before the second amount of funds is distributed to the one or more market participants that purchased asset-backed tokens as part of the offering. For example, in the example above where the asset provider 140 indicates that the assets are motorcycles, after creation of offering, the asset provider 140 may receive the first amount of funds (e.g., $500,000), which may be used to make improvements to the facilities, purchase equipment, or other purposes by the asset provider 140 and the motorcycles associated with the offering may be sold, with the proceeds of the sales being used to return the second amount of funds to the market participants. In aspects, a duration of the lock-in period may be configured based on an amount of time estimated to be sufficient to allow the asset provider 140 to generate the second amount of funds (e.g., sell the 100 motorcycles). In some aspects, if the asset provider 140 recoups the second amount of funds prior to the lock-in period, the asset provider 140 could, but is not obligated to, provide the second amount of funds to the market participants prior to the lock-in period. Additionally, in aspects the asset provider 140 may not be able to provide the second amount of funds to the market participants immediately following the end of the lock-in term.

The “Transferability” data field may be configured to indicate whether market participants can transfer ownership of their asset-backed tokens during the pendency of the offering. If the transferability data field indicates that the asset-backed tokens are transferable, the market participant may transfer ownership of their asset-backed tokens to another market participant. For example, one or more market participants may desire to divest all or a portion of their asset-backed tokens. In such instances, these market participants may create secondary offerings that enable other market participants to purchase the asset-backed tokens (e.g., asset-backed tokens that are transferable according to the terms of the offerings from which they were purchased) from these market participants. In aspects, the Internet-based market platform may facilitate a marketplace for such secondary offerings. In aspects, the transferability of asset-backed tokens may be time-restricted (e.g., transferrable after the end of the lock-in term). In aspects, the transferability of asset-backed tokens may be unrestricted (e.g., transferrable at any time regardless of the status of the lock-in term).

The “Redeemability” data field may be configured to capture information that indicates whether the asset-backed tokens can be exchanged for the underlying assets identified by the request. For example, the asset provider 140 may authorize the market participants to redeem a quantity of asset-backed tokens at a retail location (e.g., the retail location 170 of FIG. 1) in exchange for the underlying asset (e.g., a motorcycle). When redemption of asset-backed tokens is authorized, the information provided in the redemption data field may include information indicating a number of asset-backed tokens that correspond to one unit of the underlying assets identified by the request. For example, assume that each of the asset-backed tokens has a benchmarked value of $1 USD, and that the offered asset value data field indicates that the offered asset value is $5,000 USD. In this example, if redemption is authorized, the information provided in the redemption data field may indicate that 5,000 asset-backed tokens may be redeemed for one unit of the underlying assets (e.g., one motorcycle).

The “Additional Terms” data field may be configured to capture other terms and conditions of the offering. For example, the inputs to this field may indicate the second amount of funds that will be returned to the market participants. In an aspect, this information may be expressed as a percentage increase in the value of the offering (e.g., for a $500,000 offering, a 20% increase in value may suggest a second amount of funds equal to $600,000). Thus, the additional terms data field may provide information that may signify the returns to the market participants. As shown above, the Create Offering interface 220 may be configured to capture information associated with an offering to be presented to the plurality of market participants 130 via the Internet-based market platform provided by the server 110. After the asset provider 140 has provided the relevant information to the data fields of the Create Offering interface 220, the asset provider 140 may select a “Submit” button configured to 222 to initiate transmission of the information to the server 110 via the communication network 160.

Although not shown in the drawings, selection of the Manage Offerings tab 214 may initiate presentation of a GUI configured to provide various functionality to the asset provider with respect to offerings of the asset provider. For example, upon the completion of an offering, the asset provider may view the offering and configure a payment of the second amount of funds to the server 110. In aspects, the asset provider may submit payments using a plurality of different funding sources, such as cryptocurrency funding sources, fiat currency funding sources, and the like. Additionally, selection of the Account tab 216 may initiate presentation of a GUI configured to provide various functionality to the asset provider for managing an account of the asset provider. For example, the GUI may enable the asset provider to configure funding sources that may be used to provide funds to the asset provider, such as one or more of the funding sources 150 of FIG. 1.

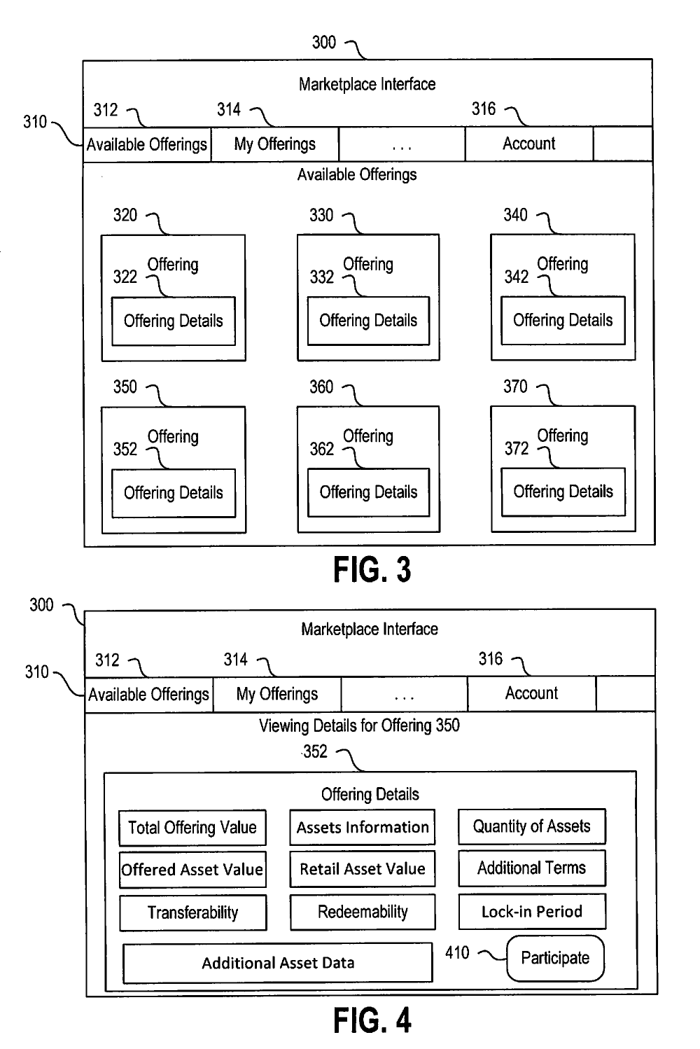

In response to receiving the information captured by the Create Offering interface 220, the server 110 may create an offering of a first quantity of asset-backed tokens, and the offering may be presented to one or more market participants via the Internet-based market platform. For example, and referring to FIG. 3, a block diagram illustrating an exemplary GUI for viewing one or more offerings of asset-backed tokens in accordance with aspects of the present disclosure is shown as a GUI 300. In aspects, the GUI 300 may be an interface provided by a program administered or supported by functionality of the server 110 of FIG. 1, such as the functionality of the market module 124 that provides the Internet-based market platform that enables market participants to view and participate in one or more offerings of asset-backed tokens in accordance with aspects of the present disclosure.

As shown in FIG. 3, the GUI 300 includes one or more selectable tabs 310 to facilitate navigation by the user/market participant to one or more screen views of the GUI 300 configured to provide information that enables the market participants to view information associated with offerings and manage an account with the system 100 of FIG. 1. For example, in FIG. 3, the GUI 300 includes an Available Offerings tab 312, a My Offerings tab 314, other tabs (not shown in FIG. 3) that may provide additional information and/or functionality to the market participants, and an Account tab 316. In FIG. 3, the Available Offerings tab 312 is selected. Upon selection of tab 312, a plurality of available offerings are displayed which are represented by selectable offering tiles 320, 330, 340, 350, 360, 370. In aspects, each available offering may correspond to a different offering generated via interaction between an asset provider and server 110. For example, each of the available offerings may have been generated in a manner similar to the process described above with respect to the GUI 200 of FIG. 2. In one aspect, Offering 320 may correspond to an offering initiated by a first asset provider, Offering 330 may correspond to an offering initiated by a second asset provider, and so on. In yet another aspect, multiple displayed offerings may correspond to different offerings initiated by a single asset provider. It is noted that the particular arrangement of the offerings (e.g., as a grid of “tiles”) within the GUI 300 of FIG. 3 has been provided for purposes of illustration, rather than by way of limitation, and that other arrangements and compositions of information pertaining to available offerings (e.g., list views, views with more or less information, and the like) may be provided in accordance with aspects of the present disclosure.

As shown in FIG. 3, the Offering tiles 320, 330, 340, 350, 360, 370 may also include respective offering details 322, 332, 342, 352, 362, 372. Such details may include any details pertaining to the corresponding offering (e.g., information captured by the GUI 200 of FIG. 2), and in some aspects may display high level details that would be more pertinent to a market participant that is initially browsing for an offering. In the event that a market participant desires to learn more about a particular offering, or would like to participate in an offering, the market participant may select one of selectable tiles 320, 330, 340, 350, 360, 370 to view a zoomed or expanded view of the selected offering.

In aspects, the offerings presented within the GUI 300 in response to selection of the Available Offerings tab 312 may be classified into one or more offering tiers, and may be arranged and/or listed according to their respective tier classifications. In aspects, the tiers may convey information relating to the asset providers corresponding to each of the presented offerings. For example, the tier classifications may, in some aspects, convey risk information relating to the asset providers, such as offerings associated with a first tier classification (e.g., “Tier 1” offerings) may pose less risk than offerings associated with a second tier classification (e.g., “Tier 4” offerings). In aspects, an offering may be assigned to a particular tier classification as part of the process performed by the marketplace module 124 of FIG. 1, such as during the creation of the offering, but prior to presenting or publishing the offering to the Internet-based market platform. In aspects, the tier classification may be determined by the marketplace module 124 based on a variety of factors, such as the size of the asset provider, previous performance of the asset provider within the Internet-based market platform and/or traditional markets, a reputation of the asset provider (e.g., derived from a third party rating system), a total value of the offering, information received by the operator of the server 110 from the asset provider (e.g., information obtained during a vetting process performed prior to authorizing the asset provider to request offerings via the Internet-based market place), and other factors. In aspects, different offerings of a single service provider may be assigned different tier classifications. For example, a small asset provider may establish a first offering that is assigned a “Tier 1” classification, and another offering by this asset provider may be assigned a “Tier 3” classification. This may occur because the first offering, when balanced against one or more of the factors considered during the classification process, posed less risk than the second offering. One of ordinary skill in the art would understand that multiple factors, such as the certainty of the existence of the assets, revenues of the company, debts of the company, the total value of the offering, and the like could be taken into consideration when assigning a tier classification.

For example, and referring to FIG. 4, a block diagram illustrating an exemplary GUI for viewing details of an offering of asset-backed tokens in accordance with aspects of the present disclosure is shown. In the particular example illustrated in FIG. 4, a zoomed or expanded view of the offering associated with Offering tile 350 is displayed (e.g., in response to a user selecting Offering 350 of FIG. 3). The expanded view may provide a listing of details 352 of the offering and/or may provide an additional plurality of selectable tiles which may be selected by the market participant to view a more detailed description of particular details of the offering being viewed. For example, the offer details displayed in the GUI 300 of FIG. 3 may include a subset of the information provided by the asset provider 140 during configuration of the offering (e.g., using the GUI 200 of FIG. 2), and the expanded view illustrated in FIG. 4 may present more information regarding the details regarding the information provided by the asset provider 140 during configuration of the offering.

Such additional details or information may provide the user/market participant with a detailed understanding regarding terms of the offering. For example, a user may be provided with the total value of the offering (e.g., the first amount of funds to be provided to the asset provider that created the offering), a rate of return on invested value, details regarding the assets offered to back the value of the tokens issued in connection with the offering, the amount or quantity of assets, the actual (e.g., market or retail) value of the assets, and the offered value of the assets (which may be less than the actual value, as described above). The user may also be provided with details corresponding to the offer such as the length of time required for participation (e.g., a lock-in period) in an offer, or whether asset-backed tokens purchased in connection with the offering are transferable. Still further, in some aspects the user may be provided with details regarding whether a quantity of the asset-backed tokens may be redeemed to obtain the underlying asset itself, and any processes that may need to be performed to execute redemption of the asset-backed tokens for the underlying asset. As shown in FIG. 4, the expanded view may include a participate button 410 which, when selected, may initiate presentation of an updated GUI configured to facilitate the purchase of a quantity of asset-backed tokens issued in connection with the offering being viewed (e.g., the offer 350 of FIG. 3).

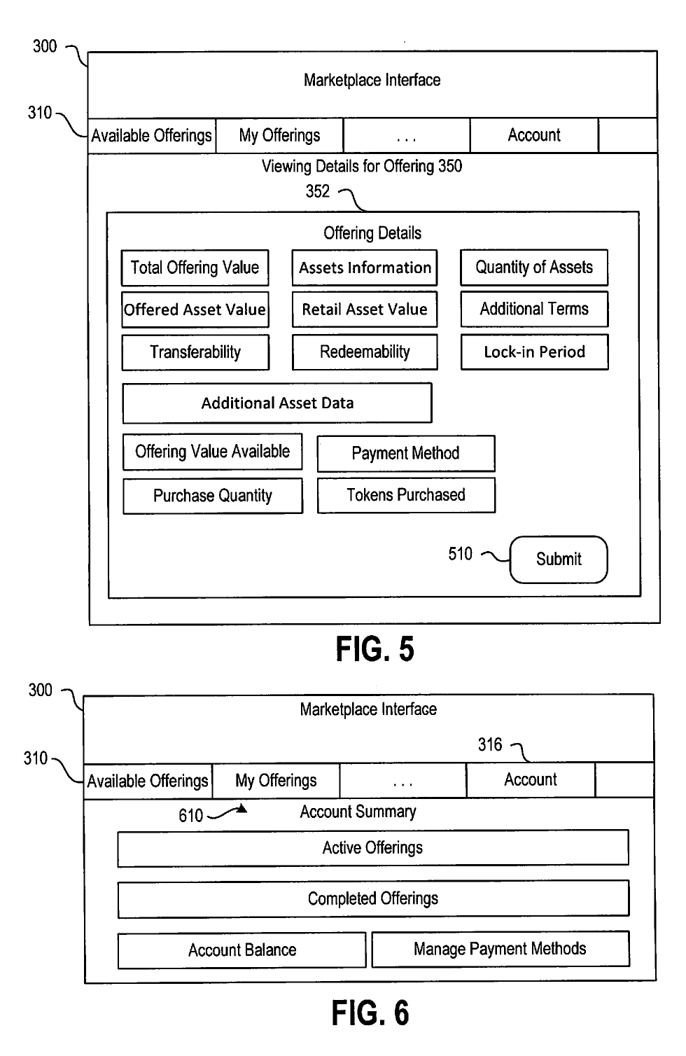

For example, and referring to FIG. 5, a block diagram illustrating an exemplary GUI for configuring a purchase of a quantity of asset-backed tokens corresponding to an offering in accordance with aspects of the present disclosure is shown. As shown in FIG. 5, upon selection of the participate button 410, the expanded view may continue to display all or a portion of details 352 of the offering 350, but may be updated to include additional information relating to the offering, such as information pertaining to the remaining availability of the offering. For example, if the offering 350 initially had a total offer value of $500,000, but 250,000 asset-backed tokens corresponding to the offering 350 had been sold, the remaining availability information for the offering 350 may indicate a remaining value of $250,000. Additionally, upon selection of the participate button 410, the expanded view may be updated to include interactive elements that the market participant may use to input information relating to the amount of funds that will be used to purchase a quantity of asset-backed corresponding to the offering 350, information designating a payment method for the purchase, and the amount of asset-backed tokens that are purchased based on the amount of funds used.

For example, if there are 5,000 asset-backed tokens remaining to be purchased in the offer 350, such a quantity may be displayed in the Offering Value Available portion of expanded view 352. In aspects, this may be reflected in the Offering Value Available field as the value of the available asset-backed tokens (e.g., $5,000) and/or may be reflected as an amount of asset-backed tokens. Additionally, if the market participant wanted to purchase $2,000 USD worth of asset-backed tokens, such a quantity may be entered in the Purchase Quantity field. A user may input the method of payment or funding source (such as funding sources 152, 154, 156, or with an account administered by server 110) in Payment Method field, and the Tokens Purchased field may be filled in based on the number of tokens that can be purchased using the specified $2,000 USD worth of funds. For example, if the asset-backed tokens were benchmarked using a base unit of $1 USD, the Tokens Purchased field may be updated to reflect that the market participant is purchasing 2,000 asset-backed tokens. It is noted that in some aspects the Tokens Purchased field may allow for a fractional purchase of tokens. In another aspect, the Tokens Purchased field may be programmed to round to a whole number, or to a fractional number such as in tenth or quarter increments, of tokens to be purchased which will cause the Purchase Quantity value to be adjusted to reflect a new amount of funds needed to purchase the rounded Tokens Purchased amount. When the details of the purchase quantity, method of payment, and the like, are sufficiently entered such that the market participant has fully specified the asset-backed token purchase, the market participant may select the submit 510 button to complete the purchase. In aspects, selection of the submit button 510 may trigger operations of the funding module 122 (e.g., to process the payment of the specified amount of funds through one of the funding sources, as described above with reference to FIG. 1) and may also trigger operations of the tokenization module 126 (e.g., to record information indicating the purchase of the asset-backed tokens by the market participant, as described above with reference to FIG. 1).

Referring to FIG. 6, a block diagram illustrating an exemplary GUI for managing an account with a system configured to create and distribute asset-backed tokens in accordance with aspects of the present disclosure is shown. In aspects, the exemplary GUI illustrated in FIG. 6 may be presented in response to selection of the account tab 316, and may provide functionality that allows a market participant to manage various aspects of their interactions with system 100. In the illustrated GUI, an account summary 610 provides various fields and selectable tiles which allow a user to view information regarding various aspects of their account and to modify rules governing interactions between the market participant and the system. For example, the account summary view 610 allows a user to view information regarding active offerings (e.g., offerings for which the market participant has previously purchased asset-backed tokens, but for which the second amount of funds has not been received from the asset provider), completed offerings (e.g., in order to track returns, and the like), account balance information, and the like. In aspects, the account balance may show the number/value of tokens and/or other value (e.g. fiat currency, cryptocurrency, etc.) currently held in the market participant's account. Additionally, a user may want to store and manage details relating to one or more payment methods to ensure faster transaction speeds when participating in offerings. It is appreciated that account tab 316 may cause any number of elements and types of information to be displayed that will assist a user in maintaining and/or managing its account, and that the particular information and elements illustrated in FIG. 6 are provided for purposes of illustration, rather than by way of limitation.

In aspects, the account tab 316 may provide additional functionality to the market participant. For example, the market participant may be provided with an interface (not shown in FIG. 6) that enables the market participant to designate how funds should be distributed to the market participant upon receipt of the second amount of funds from an asset provider for particular offerings in which the market participant is engaged. This may enable the market participant to designate that funds to be distributed to the market participant in connection with an offering should be distributed in a particular type of currency (e.g., fiat currency, a particular type of cryptocurrency, etc.). It is noted that the designated type of funds to be used for the distribution of funds to the market participant may be different from the type of funds used to purchase asset-backed tokens. For example, the market participant may purchase a quantity of asset-backed tokens using a first type of funds (e.g., Bitcoin), and, upon conclusion of the offering (e.g., when the asset provider provides the second amount of funds to the system 100), a distribution of funds to the market participant may utilize a second type of funds (e.g., fiat currency, Ethereum, etc.). It is noted that in some aspects, the user may configure his/her preference such that transactions utilize a single type of funds for transactions with the system 100 (e.g., purchases and distributions utilize the same type of currency).

In aspects, a market participant may provide a rating for asset providers corresponding to offerings for which the market participant purchased asset-backed tokens. For example, when viewing the active and/or completed offerings, the information presented to the market participant may include interactive elements that allow the market participant to rate one or more asset provider. The ratings may be expressed using a star system (e.g., 1 star, 2 star, 5 star, etc.), a numerical value (e.g., 1 out of 10, 8 out of 10, and the like), or other rating systems. Additionally, the interactive elements may enable the market participant to write a comment regarding why a particular rating was given, prompt the market participant to answer one or more questions regarding a particular offering and/or asset provider, or other mechanisms that enable the market participant to provide feedback associated a particular offering and/or asset provider. In aspects, the ratings generated based on the feedback provided by the market participants may provide an additional factor that is considered when assigning an offering of a particular asset provider to a tier classification. In aspects, information regarding an overall rating for an asset provider may be indicated when the market participant is browsing available offerings via the Internet-based market platform.

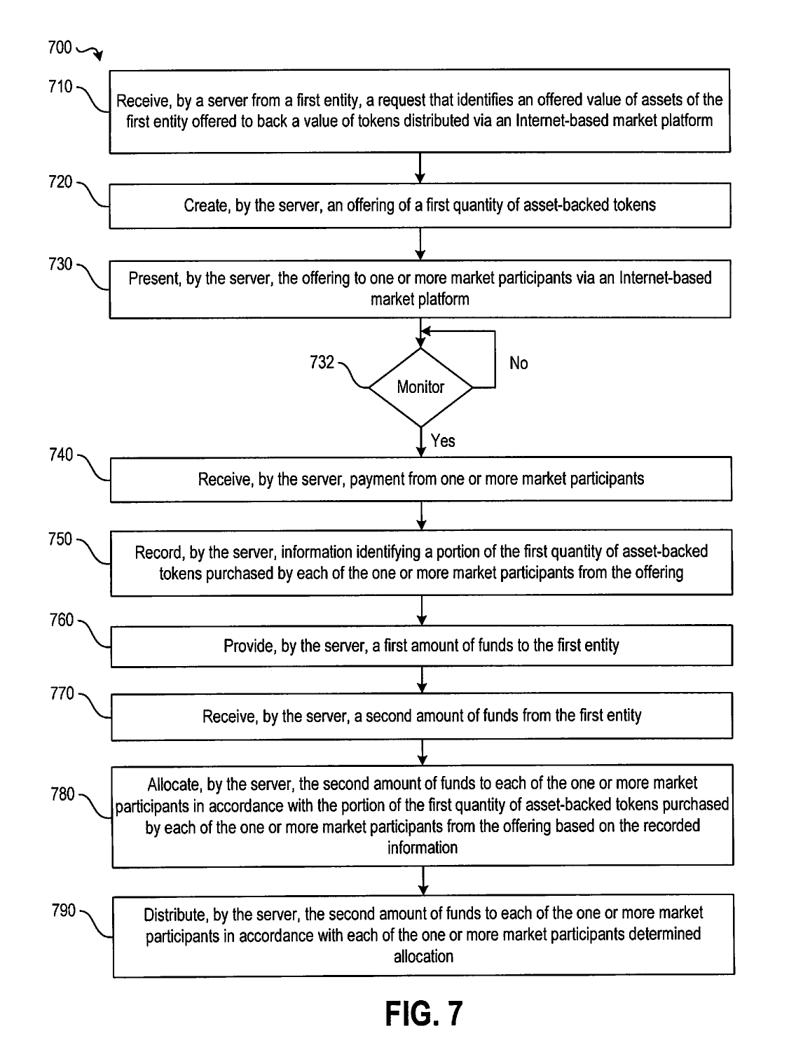

Referring to FIG. 7, a flow diagram of an exemplary method for creating and distributing asset-backed tokens in accordance with aspects of the present disclosure is illustrated as a method 700. It is appreciated that method 700 may be implemented within a system, such as system 100 of FIG. 1, using the computing devices, servers, processing resources and communications network described above. At step 710, the method 700 includes receiving, at a server, a request from a first entity that identifies an offered value of assets of the first entity to back a value of tokens distributed via an Internet-based market platform. As described above, assets which back the value of tokens may include one or more goods and services offered by the first entity. Method 700 further includes, at step 720, creating, by the server, an offering of a first quantity of asset-backed tokens, and, at step 730, presenting the created offering to one or more market participants via an Internet-based market platform.

As shown at 732, if no market participants decide to participate in the offering, method 700 continues to monitor for participation. When a market participant chooses to participate, at step 740, the server receives payment from one or more market participants. Such payment corresponds to a purchase of at least a portion of the first quantity of the asset-backed tokens from the offering, and may trigger operations of the funding module 122. At step 750, the method includes recording, by the server, information identifying a portion of the first quantity of asset-backed tokens purchased by each of the one or more market participants from the offering. In aspects, the recording may be performed by the tokenization module 126 of FIG. 1, as described above.

With the funds obtained from the purchase of asset-backed tokens, the server may then provide, at step 760, a first amount of funds to the first entity. In aspects, the first amount of funds may have a value equal to the offered value of the assets of the first entity which were offered to back the value of the asset-backed tokens issued to market participants who are participating in the offering. It is appreciated that the offered value may correspond to an actual value or cost of the assets used to back the value of the tokens, or may be defined as something less than the actual value. Additionally, in some aspects the funds provided to the asset provider may not have value equal to the offered value of the assets. For example, the operator of the server 110 may deduct a transaction fee from the first amount of funds.

Method 700 may further include, at step 770, receiving, by the server, a second amount of funds from the first entity. As explained above, the second amount of funds may have a value that is greater than the value of the assets of the first entity that were offered to back the first quantity of asset-backed tokens issued in connection with the offering. It is appreciated that this second amount of funds may comprise the original amount of funds plus an additional amount that was defined in the details of the original offering, as described above. The second amount of funds are then, at step 780, allocated by the server to each of the one or more market participants in accordance with the portion of the first quantity of asset-backed tokens purchased by each of the one or more market participants from the offering based on the recorded information. It is appreciated that in one aspect, the second amount of funds allocated to a first market participant of the one or more market participants will be proportional to a first portion of the first quantity of asset-backed tokens purchased by the first market participant from the offering. That is to say, if the first market participant purchased “X %” of the total asset-backed tokens for a particular offering, the first market participant would be allocated “X %” of the second amount of funds. The second amount of funds are then distributed by the server to each of the one or more market participants in accordance with each of the one or more market participants determined allocation, at step 790.

Method 700 may include additional functionality described above using the computing devices described above with respect to FIGS. 1-6. For example, method 700 may include aspects where the first market participant purchases the first portion of the first quantity of asset-backed tokens from the offering using a first cryptocurrency. Additionally, the second amount of funds allocated to the first market participant may be distributed to the particular market participant using the first and/or a second cryptocurrency. In some aspects each of the asset-backed tokens corresponds to one or more units of an asset-backed cryptocurrency. Still further aspects may include a circumstance where the second amount of funds allocated to the first market participant is distributed to an account of the particular market participant with Internet-based market platform.

In some aspects the request from the first entity may define a control policy which triggers one or more operations with respect to first quantity of the asset-backed tokens. For example, the control policy may include a time criterion that specifies a minimum amount of time before the second amount of funds is distributed to the one or more market participants. The control policy may also include information that indicates whether ownership of portions of the first quantity of asset-backed tokens are transferable by the one or more market participants. In aspects where such a request is received to transfer ownership of the first quantity of asset-backed units tokens purchased by a particular market participant, the system may create a second offering to purchase the portion of the first quantity of asset-backed tokens via an Internet-based market platform. The control policy may further define or include information that identifies a second amount of funds to be distributed to the one or more market participants and may also have information that indicates whether the asset-backed tokens can be exchanged for the underlying assets identified by the request. Further, the control policy may identify a number of asset-backed tokens that correspond to one unit of the underlying assets identified by the request.

In aspects, the entity operating the server 110 may provide the functionality of the system 100, as described above with respect to FIGS. 1-7, as a white label solution. In aspects, providing the white label solution may include creating an Internet-based market platform that has been customized to the specifications of an asset provider, such as to include branding elements (e.g., trademarks, logos, etc.) associated with the asset provider in the various GUIs of the Internet-based market platform. The white label solution may be provided as a standalone solution in which the asset provider operates and maintains a system (e.g., a system 100 of FIG. 1) configured to create and present offerings to market participants via an Internet-based market platform specific to the asset provider (e.g., all offerings are created by the asset provider). This allows the asset provider to maintain control over all aspects of the offerings and Internet-based market platform. In some aspects, asset providers utilizing standalone white label systems configured according to aspects of the present disclosure may operate under a license from the operator of the server 110. In aspects, in addition to providing the white label solution in a standalone manner, the white label solution may also be provided as a service by the operator of the server 110. For example, the operator of the server 110 may customize (e.g., “brand”) a set of GUIs for a particular asset provider, and these GUIs may provide an Internet-based market platform specific to particular asset provider. In this example, the server 110 may provide backend functionality (e.g., the functionality provided by the funding module 122, the marketplace module 124, and the tokenization module 126, and other aspects of the system 100 described above with respect to FIGS. 1-7) to support the asset provider branded Internet-based market platform. In aspects, providing the white label solution as a service enables the asset provider to create offerings that maintain the branded appearance of the asset provider, which may lend credibility to, and increase interest in, the offering, but may be administered by a third party (e.g., the operator of the server 110). In aspects, in addition to providing white label solutions to asset providers, the white label solution may be provided (either as a standalone solution or service) to other third party entities desiring to provide an Internet-based market place system. Persons of ordinary skill in the art would recognize that other benefits and advantages may be realized by an asset provider that implements a white label solution in accordance with aspects of the present disclosure.

The following discussion illustrates various use-cases for the above-described systems and methods in accordance with aspects of the present application. Such uses are provided in order to illustrate potential uses and benefits of the described systems and methods. One of skill in the art would understand that the specific actions described are given by way of example are not intended to be limiting.

### Example 1

A provider entity is a motorcycle manufacturer which desires to raise capital (access liquidity). The manufacturer sells a specific model of motorcycle and has 100 units of inventory that have a cost of $5,000/unit and a retail value of $7,000/unit. The motorcycle manufacturer may utilize the Internet based market platform to create an initial coin offering that issues coins/tokens that correspond to the value of the 100 units ($500,000). In this example, each unit will correspond to 1 token, but it is understood that other valuations may be used. The Internet based market platform may take steps to verify the existence of the 100 units, or to prove the existence of manufacturing commitments, and also to specify the details, terms, and conditions for the offering. For example, the offering may specify that there is a lock-in period of 6 months. This would be based on an estimated timing that the motorcycle manufacturer believes that the units would require to be shipped, sold, and to receive payment from the sales. The offering may also specify a yearly rate of return on the purchased units; in this example the rate is 20%. When the offering is fully specified, the offering is generated and published by a market platform, such as server 110.

The offering runs and concludes when all tokens are sold. The funds used to purchase the tokens ($500,000) are then provided to the manufacturer. As discussed above, the funds used to purchase the tokens can come from various sources such as fiat currencies, crypto-currencies, etc. Such funds are handled by the market platform and the manufacturer is provided funds in the medium specified by the offering.

The motorcycles are then sold over a period of 6 months at their specified retail price for a total value of $700,000. The manufacturer now has $200,000 in gross profit. Per the conditions of the offering, the manufacturer provides funds to the market platform equal to the $500,000 plus $50,000 of the $200,000 profit. This leaves the manufacturer with $150,000 in profit and the token holders with a $50,000 return which is a 20% per annum return since the offering completed in 6 months. The initial capital and return funds are then distributed to the token holders in proportion to their token ownership. The funds may be distributed in any manner determined by the holder and/or market platform, e.g., fiat currency, a digital cryptocurrency corresponding to the market platform, any other type of cryptocurrency, or can be stored in an account hosted by the market platform.

Accordingly, this example scenario provides liquidity to a manufacturer in a timely manner which allows the company to pursue other endeavors without requiring the company to assent to unfavorable terms of traditional funding sources. It further provides opportunities to a broad range of market participants which can benefit from providing the funds, while having their tokens backed by assets.

### Example 2

A provider entity is medical services provider which desires to raise capital (access liquidity) to, for example, expand its facilities. The medical services provider sells a specific test, such as an Magnetic Resonance Imaging scan, and expects to sell 2000 of these tests in the next year at a cost of $1,000/test and where the customer will be charged $2,000/test. The medical services provider may utilize the Internet based market platform to create an initial coin offering that issues coins/tokens that correspond to the value of 1000 of the tests ($1,000,000). In this example, each unit will correspond to 1 token, but it is understood that other valuations may be used. The Internet based market platform may take steps to verify the history of the provider to ensure that their number of tests specified by the offering will be implemented, and also to specify the details, terms, and conditions for the offering. For example, the offering may specify that there is a lock-in period of 1 year. This would be based on an estimated timing that the medical services provider believes that the test would be implemented and payment for such tests are received. The offering may also specify a yearly rate of return on the purchased tests, in this example the rate is 20%. When the offering is fully specified, the offering is generated and published by a market platform, such as server 110.

The offering runs and concludes when all tokens are sold. The funds used to purchase the tokens ($1,000,000) are then provided to the medical services provider. As discussed above, the funds used to purchase the tokens can come from various sources such as fiat currencies, crypto-currencies, etc. Such funds are handled by the market platform and the medical services provider is provided funds in the medium specified by the offering.

The tests are then sold over a period of 1 year at their specified price for a total value of $2,000,000. The medical services provider now has $1,000,000 in gross profit. Per the conditions of the offering, the medical services provider provides funds to the market platform equal to the $1,000,000 plus $200,000 of the $1,000,000 profit. This leaves the medical services provider with $800,000 in profit and the token holders with a $200,000 return which is a 20% per annum return. The initial capital and return funds are then distributed to the token holders in proportion to their token ownership. The funds may be distributed in any manner determined by the holder and/or market platform, e.g., fiat currency, a digital cryptocurrency corresponding to the market platform, any other type of cryptocurrency, or can be stored in an account hosted by the market platform.

Accordingly, this example scenario provides liquidity to a medical services provider in a timely manner which allows the medical services provider to pursue other endeavors without requiring the medical services provider to assent to unfavorable terms of traditional funding sources. It further provides opportunities to a broad range of market participants which can benefit from providing the funds, while having their tokens backed by assets, which in this case are medical tests.

It is further appreciated that this Internet-based market platform could be utilized by market participants in other ways to benefit the market participants. For example, in the medical services provider case, the asset may be yearly physical examinations. A token holder may in some cases redeem a token for the asset itself and receive the service that backs the asset. In this manner, the Internet-based market platform may be utilized as a medical savings account (or a substitute for health insurance) where funds are placed in the account that can obtain returns, but can also be used to redeem an asset. It is appreciated that goods or services backing an asset do not have to be only one type of good or service and it could include both goods and services. Such goods and services utilized in an offering can be defined in any manner which provides a mutually beneficial relationship between an entity and a market participant. It is not possible to describe every permutation of offering and potential terms that would accompany such an offering. But such permutations would be understood to be within the scope of the present application.

Although embodiments of the present application and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. Moreover, the scope of the present application is not intended to be limited to the particular embodiments of the process, machine, manufacture, composition of matter, means, methods and steps described in the specification.

1. A method for creating and distributing asset-backed tokens, the method comprising:
receiving, by a server, a request from a first entity that identifies an offered value of assets of the first entity offered to back a value of tokens distributed via an Internet-based market platform;
creating, by the server, an offering of a first quantity of asset-backed tokens;
presenting, by the server, the offering to one or more market participants via an Internet-based market platform;
receiving, by the server, payment from one or more market participants, wherein, for each of the one or more market participants, the received payment corresponds to a purchase of at least a portion of the first quantity of the asset-backed tokens from the offering;
recording, by the server, information identifying a portion of the first quantity of asset-backed tokens purchased from the offering by each of the one or more market participants; and
providing, by the server, a first amount of funds to the first entity, the first amount of funds having a value equal to the offered value of the assets of the first entity offered to back the first quantity of asset-backed tokens.

2. The method of claim 1, further comprising:
receiving, by the server, a second amount of funds from the first entity, the second amount of funds having a value greater than the value of the assets of the first entity offered to back the first quantity of asset-backed tokens of the offering;
allocating, by the server, the second amount of funds to each of the one or more market participants in accordance with the portion of the first quantity of asset-backed tokens purchased from the offering by each of the one or more market participants based on the recorded information, wherein the second amount of funds allocated to a first market participant of the one or more market participants is proportional to a first portion of the first quantity of asset-backed tokens purchased from the offering by the first market participant; and
distributing, by the server, the second amount of funds to each of the one or more market participants in accordance with each of the one or more market participants determined allocation.

3. The method of claim 2, wherein the first market participant purchased the first portion of the first quantity of asset-backed tokens from the offering using a first cryptocurrency.

4. The method of claim 3, wherein the second amount of funds allocated to the first market participant is distributed to the particular market participant using a second cryptocurrency.

5. The method of claim 3, wherein the second amount of funds allocated to the first market participant is distributed to the particular market participant using the first cryptocurrency.

6. The method of claim 3, wherein the second amount of funds allocated to the first market participant is distributed to an account of the particular market participant with Internet-based market platform.

7. The method of claim 1, wherein the request comprises a control policy configured to trigger one or more operations with respect to first quantity of the asset-backed tokens.

8. The method of claim 7, wherein the control policy comprises a time criterion that specifies a minimum amount of time before the second amount of funds is distributed to the one or more market participants.

9. The method of claim 7, wherein the control policy comprises information that indicates whether ownership of portions of the first quantity of asset-backed tokens are transferable by the one or more market participants.

10. The method of claim 9, in response to receiving a request to transfer ownership of a portion of the first quantity of asset-backed units tokens of the offering purchased by a particular market participant, creating, by the server, a second offering to purchase the portion of the first quantity of asset-backed tokens via an Internet-based market platform.

11. The method of claim 7, wherein the control policy comprises information that identifies a second amount of funds to be distributed to the one or more market participants.

12. The method of claim 7, wherein the control policy comprises information that indicates whether the asset-backed tokens can be exchanged for the underlying assets identified by the request.

13. The method of claim 12, wherein the control policy identifies a number of asset-backed tokens that correspond to one unit of the underlying assets identified by the request.

14. The method of claim 1, wherein the assets identified by the request comprise at least one of goods and services.

15. The method of claim 1, wherein each of the asset-backed tokens corresponds to one or more units of an asset-backed cryptocurrency.

16. A system for creating and distributing asset-backed units of cryptocurrency, the system comprising:
a market place module executable by one or more processors and configured to:
receive, from a first entity, a request that identifies a value of assets of the first entity offered to back a value of tokens distributed via an Internet-based market platform;
create an offering of a first quantity of asset-backed tokens responsive to the request;
present the offering to one or more market participants via an Internet-based market platform; and
receive payment information from one or more market participants, wherein, for each of the one or more market participants, the received payment information is associated with a purchase of at least a portion of the first quantity of the asset-backed tokens from the offering;
a funding module executable by the one or more processors and configured to:
process the payment information to retrieve funds from one or more funding sources; and
provide a first amount of funds to the first entity, the first amount of funds having a value equal to the value of the assets of the first entity offered to back the first quantity of asset-backed tokens; and
a tokenization module executable by the one or more processors and configured to:
generate the first quantity of asset-backed tokens corresponding to the offering; and
record information identifying a portion of the first quantity of asset-backed tokens purchased from the offering by each of the one or more market participants.

17. The system of claim 16, wherein the funding module is further configured to:
receive a second amount of funds from the first entity, the second amount of funds having a value greater than the first amount of funds;
allocate, based on the recorded information, the second amount of funds to each of the one or more market participants in accordance with the portion of the first quantity of asset-backed tokens purchased from the offering by each of the one or more market participants, wherein the second amount of funds allocated to a first market participant of the one or more market participants is proportional to a first portion of the first quantity of asset-backed tokens purchased from the offering by the first market participant; and
distribute the second amount of funds to each of the one or more market participants in accordance with each of the one or more market participants determined allocation.

18. The system of claim 17, wherein the funding module is configured to convert an amount of funds received from a particular market participant in connection with a purchase of a quantity of asset-backed tokens to an amount of funds in a native cryptocurrency, and use the converted amount of funds in the native cryptocurrency to complete the purchases of the quantity of asset-backed tokens.

19. The system of claim 17, wherein the request comprises a control policy configured to trigger one or more operations with respect to first quantity of the asset-backed tokens, wherein the control policy defines:
a time criterion that specifies a minimum amount of time before the second amount of funds is distributed to the one or more market participants;
a transferability parameter that indicates whether ownership of portions of the first quantity of asset-backed tokens are transferable by the one or more market participants; and
a return parameter that identifies a second amount of funds to be distributed to the one or more market participants.

20. A non-transitory computer-readable storage medium storing instructions that, when executed by one or more processors, cause the one or more processors to perform operations for creating and distributing asset-backed units of cryptocurrency, the operations comprising:
receiving, from a first entity, a request that identifies a value of assets of the first entity offered to back a value of tokens distributed via an Internet-based market platform;
creating an offering of a first quantity of asset-backed tokens;
presenting the offering to one or more market participants via an Internet-based market platform;
receiving payment from one or more market participants, wherein, for each of the one or more market participants, the received payment corresponds to a purchase of at least a portion of the first quantity of the asset-backed tokens from the offering;
recording information identifying a portion of the first quantity of asset-backed tokens purchased from the offering by each of the one or more market participants;
providing a first amount of funds to the first entity, the first amount of funds having a value equal to the value of the assets of the first entity offered to back the first quantity of asset-backed tokens;
receiving a second amount of funds from the first entity, the second amount of funds having a value greater than the value of the assets of the first entity offered to back the first quantity of asset-backed tokens of the offering;
allocating the second amount of funds to each of the one or more market participants in accordance with the portion of the first quantity of asset-backed tokens purchased from the offering by each of the one or more market participants based on the recorded information, wherein the second amount of funds allocated to a first market participant of the one or more market participants is proportional to a first portion of the first quantity of asset-backed tokens purchased from the offering by the first market participant; and
distributing the second amount of funds to each of the one or more market participants in accordance with each of the one or more market participants determined allocation.
